(19) United States
(12) Patent Application Publication
(10) Pub. No.: US 2021/0282433 A1
(43) Pub. Date: Sep. 16, 2021

(54) METHOD FOR PREPARING CALCIUM CARBONATE-BASED EDIBLE COLORANT LAKE

(71) Applicant: BEIJING TECHNOLOGY AND BUSINESS UNIVERSITY, Beijing (CN)

(72) Inventors: Dongdong YUAN, BEIJING (CN); Chengtao WANG, BEIJING (CN); Guorong LIU, BEIJING (CN); Lei CHENG, BEIJING (CN); Shuai HAO, BEIJING (CN); Baoguo SUN, BEIJING (CN)

(21) Appl. No.: 17/335,022

(22) Filed: May 31, 2021

Related U.S. Application Data
(63) Continuation of application No. PCT/CN2020/095850, filed on Jun. 12, 2020.

(30) Foreign Application Priority Data
Jun. 14, 2019 (CN) 201910512968.5

(51) Int. Cl. A23L 5/47; C09B 63/00

(52) U.S. Cl. CPC A23L 5/47; A23V 2002/00; C09B 63/00

(57) ABSTRACT

The disclosure belongs to the technical field of food additives, and provides a method for preparing a calcium carbonate-based edible lake. The method comprises the following steps: S1, dissolving carbonate in water to obtain carbonate solution; S2, dissolving water-soluble anionic pigment into the carbonate solution obtained in step S1 to obtain mixed solution; S3, adding hydrochloric acid to the mixed solution obtained in step S2 to adjust pH to 7-10.5; S4, dissolving a calcium salt into water and then adding the above solution into the solution obtained in step S3, controlling the pH of the mixed solution to 6-9, carrying out ultrasound treatment for 1-10 min, centrifuging to obtain a calcium carbonate precipitate adsorbed with pigment; and S5, drying and grinding the calcium carbonate precipitate adsorbed with pigment obtained in step S4 to obtain the calcium carbonate-based edible lake.

### CROSS-REFERENCE TO RELATED APPLICATIONS

This application is a continuation of International Patent Application No. PCT/CN2020/095850 with a filing date of Jun. 12, 2020, designating the United States, now pending, and further claims priority to Chinese Patent Application No. 201910512968.5 with a filing date of Jun. 14, 2019. The content of the aforementioned applications, including any intervening amendments thereto, are incorporated herein by reference.

### TECHNICAL FIELD

The disclosure belongs to the technical field of food additives, and relates to a method for preparing a calcium carbonate-based edible lake.

### BACKGROUD OF THE PRESENT INVENTION

Colorant lake is a non-water-soluble pigment product which is prepared by adsorbing a water-soluble pigment onto a non-water-soluble matrix in aqueous solution, and then separating and drying the obtained precipitate (matrix with adsorbed pigment). Compared with the pigment itself, the lake has better dispersibility, and can dye high-fat food (such as cream and chocolate) and dry powder food (such as milk powder). The lake is widely applied, is low in replaceability, and is a necessary raw material in food, medicine and cosmetics industries.

In the preparation of edible lake, aluminum hydroxide is the traditional and most widely used adsorption matrix. At present, all the lakes approved in China's food safety national standards for the usage of food additives are aluminum hydroxide lakes, including indigo carmine aluminum lake, brilliant blue aluminum lake and tartrazine aluminum lake.

The invention patent application with publication No. CN 1515183A “preparation method for an edible lake as a special food additives” describes a method for preparing an edible lake by adjusting the temperature, pH value and mass ratio of the formation reaction using aluminum trichloride and sodium bicarbonate as reactants.

Traditionally, aluminum is considered as a very safe metal element. Aluminum pots, aluminum-containing raising agents, water purifying agents and the like are widely applied. However, as food technology is developed, people are gradually aware of that the aluminum element is not completely safe, which has been supported by more and more evidences. A large number of studies have shown that long-term consumption of a diet with excessive aluminum increases the incidence of breast cancer. In addition, aluminum has also been proved to be neurotoxic, and its excessive intake could lead to Alzheimer's disease as evidenced. Excessive intake of aluminum could also affect the development of bones and nervous system in infants.

Compared with the old version of “food safety national standards for the usage of food additives”, namely GB 2760-2011, the new version of “standard” GB 2760-2014 canceled the use of indigo carmine aluminum lake in puffed food. In addition, the use range of aluminum potassium sulfate and aluminum ammonium sulfate in wheat flour, wheat-flour-based products, as well as aquatic products was adjusted. In addition, three varieties of aluminum-containing food additives including acidic sodium aluminum phosphates, sodium aluminosilicate and aluminum starch octenylsuccinate were revoked. These changes reflect increasing concerns about the aluminum element.

Therefore, considering the potential health hazards of the aluminum element, as well as the adsorption ability, safety and dyeing ability of the adsorption matrix, technicians have been looking for an adsorption matrix capable of replacing aluminum hydroxide, but no breakthrough has been realized all the time.

### SUMMARY OF PRESENT INVENTION

The disclosure provides a method for preparing a calcium carbonate-based edible lake, solving the problems which cannot be solved due to potential safety hazard in aluminum lake in the prior art.

The technical solution of the disclosure is achieved as follows:

Provided is a method for preparing a calcium carbonate-based edible lake, comprising the following steps:

S1, dissolving carbonate in water to obtain carbonate solution;

S2, dissolving water-soluble anionic pigment into the carbonate solution obtained in step S1 to obtain mixed solution;

S3, adding hydrochloric acid to the mixed solution obtained in step S2 to adjust pH to 7-10.5;

S4, dissolving a calcium salt into water and then adding the resultant solution into the solution obtained in step Scontrolling the pH of the solution to 6-9, stirring and carrying out ultrasound treatment for 1-10 min, and centrifuging to obtain a calcium carbonate precipitate adsorbed with pigment; and

S5, drying and grinding the calcium carbonate precipitate adsorbed with pigment obtained in step S4 to obtain a calcium carbonate-based edible lake.

As a further technical solution, in step S1, carbonate is sodium carbonate or potassium carbonate.

As a further technical solution, in step S2, the water-soluble anionic pigment is a mixture of one or more of erythrosine, indigo carmine, brilliant blue, tartrazine, amaranth, new red, Ponceau 4R, Allura Red AC and Sunset Yellow FCF.

As a further technical solution, in step S4, the calcium salt is a water-soluble calcium salt.

As a further technical solution, the water-soluble calcium salt is calcium chloride or calcium bicarbonate.

As a further technical solution, in step S4, the mole ratio of added calcium salt to carbonate is 1:1.

As a further technical solution, in step S4, the used ultrasonic frequency is 25-100 kHz.

As a further technical solution, in step S5, the drying operation is carried out at 40-80° C.

The application principle and beneficial effects of the disclosure are as follows:

In recent years, considering the safety issue of aluminum lake, technicians have been looking for a novel and safe adsorption matrix to replace aluminum hydroxide. However, due to comprehensive performances such as adsorption ability, safety and dyeing ability, breakthrough have not been realized by technicians. The disclosure uses calcium carbonate as the adsorption matrix and achieves the effective adsorption of anionic pigment onto calcium carbonate by adjusting the pH value of the mixed solution in the preparation step, adjusting the addition order of each reagent, and innovatively applying an ultrasonic assisted technology. The obtained calcium carbonate lake has good color and stability, and can replace the traditional aluminum hydroxide lake to meet most dyeing requirements, thereby solving the technical problems which cannot be solved due to potential safety hazard.

Before this patent, the difficulty of using calcium carbonate as adsorption matrix to prepare colorant lake lies in low adsorption capacity of calcium carbonate to pigment, pale color and limited application of the final lake product. Therefore, based on the research on the adsorption mechanism of calcium carbonate, the patent carefully designs the technical solution, including adjusting pH, adjusting the reagent addition order, and using the ultrasonic assisted technology, which can promote the adsorption process. Thereinto, the ultrasonic assisted technology has remarkable effect, and the mechanism is that the ultrasound wave (appropriate frequency and intensity) can change the crystallization behavior of calcium carbonate in the adsorption process to form crystal particles with smaller particle size, which consequently produces unexpected benefits, including promoted adsorption process, increased lake yield, and brighter color of the lake.

The prepared calcium carbonate-based edible lake can replace the traditional aluminum lake, which improves the safety of the edible lake, relieves consumers' worries about the aluminum element, meets the market's demand, and is suitable for a wide range of promotion and application in food, medicine, cosmetics, and other industries.

The disclosure develops a novel lake, which uses calcium carbonate to replace the traditional adsorption matrix, i.e., aluminum hydroxide, thereby realizing the adsorption of water-soluble anionic pigment. Calcium carbonate is also a calcium supplement, which increases the health effect of the novel lake while ensuring the safety, showing a promising market prospect.

### DETAILED DESCRIPTION OF PREFERRED EMBODIMENTS

Next, the technical solutions in the embodiments of the disclosure will be clearly and completely described in combination with embodiments of the disclosure. Obviously, described embodiments are only parts of the disclosure but not all the embodiments. Based on the embodiments of the disclosure, any other embodiments obtained by persons of ordinary skill in the art without creative efforts are all included in the protective scope of the disclosure.

### EXAMPLE 1

A method for preparing a calcium carbonate-based edible lake comprises the following steps:

S1, 2.0 g of sodium carbonate was dissolved into 200 mL of water to obtain sodium carbonate solution;

S2, 50.0 mg of indigo carmine was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 10.5;

S4, 2.1 g of calcium chloride was dissolved into 20 mL of water and then the above solution was added into the solution obtained in step S3, the above mixture was stirred and subjected to ultrasound treatment for 2 min at an ultrasonic frequency of 40 kHz, at this moment, suspended calcium carbonate particles were generated, the pH of the solution was about 8.2, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven at 60° C., and then grinded to obtain a calcium carbonate-based edible lake.

### EXAMPLE 2

A method for preparing a calcium carbonate-based edible lake comprises the following steps:

S1, 2.0 g of sodium carbonate was dissolved into 200 mL of water to obtain sodium carbonate solution;

S2, 50 mg of erythrosine was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 10.5;

S4, 2.1 g of calcium chloride was dissolved into 20 mL of water and then the above solution was added into the solution obtained in step S3, the above mixture was stirred and subjected to ultrasound treatment for 2 min at an ultrasonic frequency of 40 kHz, at this moment, suspended calcium carbonate particles were generated, the pH of the solution was about 7.8, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven at 50° C., and then grinded to obtain a calcium carbonate-based edible lake.

### EXAMPLE 3

A method for preparing a calcium carbonate-based edible lake comprises the following steps:

S1, 2.0 g of sodium carbonate was dissolved into 200 mL of water to obtain sodium carbonate solution;

S2, 50 mg of brilliant blue was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 10;

S4, 2.1 g of calcium chloride was dissolved into 20 mL of water and then the above solution was added into the solution obtained in step S3, the above mixture was stirred and subjected to ultrasound treatment for 5 min at an ultrasonic frequency of 60 kHz, at this moment, suspended calcium carbonate particles were generated, the pH of the solution was about 6.8, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven o at 60° C., and then grinded to obtain a calcium carbonate-based edible lake.

### EXAMPLE 4

A method for preparing a calcium carbonate-based edible lake comprises the following steps:

S1, 2.0 g of sodium carbonate was dissolved in 200 mL of water to obtain sodium carbonate solution;

S2, 50 mg of tartrazine was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 8;

S4, 2.1 g of calcium chloride was dissolved into 20 mL of water and then the above solution was added into the solution obtained in step S3, the above mixture was stirred and subjected to ultrasound treatment for 3 min at an ultrasonic frequency of 80 kHz, at this moment, suspended calcium carbonate particles were generated, the pH of the solution was about 6.6, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven of 70° C., and then grinded to obtain a calcium carbonate-based edible lake.

### EXAMPLE 5

A method for preparing a calcium carbonate-based edible lake comprises the following steps:

S1, 2.0 g of sodium carbonate was dissolved into 200 mL of water to obtain sodium carbonate solution;

S2, 50 mg of amaranth was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 9;

S4, 2.1 g of calcium chloride was dissolved into 20 mL of water and then the above solution was added into the solution obtained in step S3, the above mixture was stirred and subjected to ultrasound treatment for 5 min at an ultrasonic frequency of 60 kHz, at this moment, suspended calcium carbonate particles were generated, the pH of the solution was about 6.8, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven at 50° C., and then grinded to obtain a calcium carbonate-based edible lake.

### EXAMPLE 6

A method for preparing a calcium carbonate-based edible lake comprises the following steps:

S1, 2.0 g of sodium carbonate was dissolved into 200 mL of water to obtain sodium carbonate solution;

S2, 50 mg of new red was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 9.5;

S4, 2.1 g of calcium chloride was dissolved into 20 mL of water and then the above solution was added into the solution obtained in step S3, the above mixture was stirred and subjected to ultrasound treatment for 2 min at an ultrasonic frequency of 50 kHz, at this moment, suspended calcium carbonate particles were generated, the pH of the solution was about 6.5, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven at 60° C., and then grinded to obtain a calcium carbonate-based edible lake.

### EXAMPLE 7

A method for preparing a calcium carbonate-based edible lake comprises the following steps:

S1, 2.0 g of sodium carbonate was dissolved into 200 mL of water to obtain sodium carbonate solution;

S2, 50 mg of Ponceau 4R was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 7;

S4, 3.0 g of calcium bicarbonate was dissolved into 20 mL of water and then the above solution was added into the solution obtained in step S3, the above mixture was stirred and subjected to ultrasound treatment for 2 min at an ultrasonic frequency of 40 kHz, at this moment, suspended calcium carbonate particles generated, the pH of the solution was about 8.5, the above solution was rapidly centrifuged using a centrifugal machine, and calcium carbonate precipitates adsorbed with pigment were collected;

S5, the calcium carbonate precipitates adsorbed with pigment obtained in step S4 were dried in an oven at 60° C., and then grinded to obtain a calcium carbonate-based edible lake.

### EXAMPLE 8

A method for preparing a calcium carbonate-based edible lake comprises the following steps:

S1, 2.0 g of sodium carbonate was dissolved into 200 mL of water to obtain sodium carbonate solution;

S2, 50 mg of Allura Red AC was added into the sodium carbonate solution obtained in step S1, and sufficiently stirred so that the pigment was completely dissolved, thereby obtaining mixed solution;

S3 a proper amount of hydrochloric acid was added into the mixed solution obtained in step S2 to adjust the pH of the mixed solution to 10;

S4, 2.1 g of calcium chloride was dissolved into 20 mL of water and then the above solution was added into the solution obtained in step S3, the above mixture was stirred and subjected to ultrasound treatment for 2 min at an ultrasonic frequency of 70 kHz, at this moment, suspended calcium carbonate particles were generated, the pH of the solution was about 6.8, the above solution as rapidly centrifuged using a centrifugal machine, and calcium carbonate precipitates adsorbed with pigment were collected; and

S5, the calcium carbonate precipitates adsorbed with pigment obtained in step S4 were dried in an oven at 60° C., and then grinded to obtain a calcium carbonate-based edible lake.

### EXAMPLE 9

A method for preparing a calcium carbonate-based edible lake comprises the following steps:

S1, 2.0 g of sodium carbonate was dissolved into 200 mL of water to obtain sodium carbonate solution;

S2, 50 mg of erythrosine was added into the sodium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 10.5;

S4, 3.0 g of calcium bicarbonate was dissolved into 20 mL of water and then added the above solution into the solution obtained in step S3, the above mixture was stirred and objected to ultrasound treatment for 2 min at an ultrasonic frequency of 50 kHz, at this moment, suspended calcium carbonate particles generated, the pH of the solution was about 7.5, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven 40° C., and then grinded to obtain a calcium carbonate-based edible lake.

### EXAMPLE 10

A method for preparing a calcium carbonate-based edible lake comprises the following steps:

S1, 2.0 g of potassium carbonate was dissolved into 200 mL of water to obtain potassium carbonate solution;

S2, 50 mg of indigo carmine was added into the potassium carbonate solution obtained in step S1, and sufficiently stirred so that the pigment was completely dissolved, thereby obtaining mixed solution;

S3, a proper amount of hydrochloric acid was added into the mixed solution obtained in step S2 to adjust the pH of the mixed solution to 10;

S4, 1.6 g of calcium chloride was dissolved into 20 mL of water and then the above solution was added into the solution obtained in step S3, the above mixture was stirred and subjected to ultrasound treatment for 3 min at an ultrasonic frequency of 40 kHz, at this moment, suspended calcium carbonate particles generated, the pH of the solution was about 6.8, the above solution was rapidly centrifuged using a centrifugal machine, and calcium carbonate precipitates adsorbed with pigment were collected; and

S5, the calcium carbonate precipitates adsorbed with pigment obtained in step S4 were dried in an oven at 60° C., and then grinded to obtain a calcium carbonate-based edible lake.

### COMPARATIVE EXAMPLE 1

A method for preparing a calcium carbonate-based edible lake comprises the following steps:

S1, 2.0 g of sodium carbonate was dissolved into 200 mL of water to obtain sodium carbonate solution;

S2, 50 mg of indigo carmine was added into the sodium carbonate solution obtained in step S1, and sufficiently stirred so that the pigment was completely dissolved, thereby obtaining mixed solution;

S3, 2.1 g of calcium chloride was dissolved into water and then added into the solution obtained in step S2, wherein the pH of the obtained solution was about 10.3, the above obtained solution was subjected to ultrasound treatment for 2 min at an ultrasonic frequency of 40 kHz, the solution subjected to ultrasound treatment was rapidly centrifuged using a centrifugal machine, and calcium carbonate precipitates adsorbed with pigment were collected; and

S4, the calcium carbonate precipitates adsorbed with pigment obtained in step S3 were dried in an oven at 60° C., and then grinded to obtain a calcium carbonate-based edible lake.

### COMPARTATIVE EXAMPLE 2

A method for preparing a calcium carbonate-based edible lake comprises the following steps:

S1, 2.0 g of sodium carbonate was dissolved into 200 mL of water to obtain sodium carbonate solution;

S2, a proper amount of hydrochloric acid was added into the sodium carbonate solution obtained in step S1, and the pH of the mixed solution was adjusted to 10.5;

S3, 2.1 g of calcium chloride was dissolved into water and then the above solution was added into the solution obtained in step S2, wherein suspended calcium carbonate particles were generated, and pH was about 7.3; and

S4, 50 mg of indigo carmine was added into the suspended calcium carbonate particles obtained in step S3, the above mixture was subjected to ultrasound treatment for 2 min at an ultrasonic frequency of 40 kHz, then rapidly centrifuged using a centrifugal machine, and calcium carbonate precipitates adsorbed with pigment were collected;

S5, the calcium carbonate precipitates adsorbed with pigment obtained in step S4 were dried in an oven at 60° C., and then grinded to obtain a calcium carbonate-based edible lake.

### COMPARATIVE EXAMPLE 3

A method for preparing a calcium carbonate-based edible lake comprises the following steps:

S1, 2.0 g of sodium carbonate was dissolved into 200 mL of water to obtain sodium carbonate solution;

S2, 50 mg of indigo carmine was added into the sodium carbonate solution obtained in step S1, and sufficiently stirred to completely dissolve the pigment to obtain mixed solution;

S3, a proper amount of hydrochloric acid was added into the sodium carbonate solution obtained in step S2, and the pH of the mixed solution was adjusted to 10.5;

S4, 2.1 g of calcium chloride was dissolved into 20 mL of water and then the above solution was added into the solution obtained in step S3, wherein suspended calcium carbonate particles were generated, and pH was about 6.8, the above solution was rapidly centrifuged using a centrifugal machine, and calcium carbonate precipitates adsorbed with pigment were collected; and

S5, g the calcium carbonate precipitates adsorbed with pigment obtained in step S4 were dried in an oven at 60° C., and then grinded to obtain a calcium carbonate-based edible lake.

The edible lakes prepared in example 1 and comparative examples 1-3 are subjected to the following performance test:

1. Adsorption Capacity of Lake

In the preparation processes of example 1, comparative example 1, comparative example 2 and comparative example 3, the supernatant after centrifugation was collected, the content of indigo carmine in the supernatant was determined, and the adsorption capacity was expressed as mass of adsorbed pigment (mg) divided by mass of calcium chloride (g) used in the preparing process of lake.

2. Color

The L, a and b values of the lakes obtained in example 1 and comparative examples 1-3 were detected by a color difference meter. The b values of blue lakes were compared. The lower the b value was, the deeper the blue color was.

3. Adsorption Stability of Lake

50 mg of lakes obtained from example 1 and comparative examples 1-3 were respectively weighed and transferred to 100 mL of simulated saliva solutions (pH 7). The suspension solution was stirred at a speed of 100 rpm, the content of pigment released in the solution after 2 min was detected, and the content of the left pigment in the lake was calculated in percentage. The more the left pigment was, the more stable the lake was.

4. Color Stability of Lake

The lakes obtained from the above example 1 and comparative examples 1-3 were respectively placed in an artificial climate box, with the light intensity set as 12000 LX and the temperature set as 25° C. The change of color parameters (L, a and b) with time was detected, and the decrease of blue chroma after 48 h (the increase of b value) was taken as an indicator to measure the color stability of lake. The less the change of b value was, the higher the stability of color was.

The test results are shown in the table below.

TABLE 1
Performance test results of edible lakes prepared in example 1 and
comparative examples 1-3

| | Pigment | | | |
|---|---|---|---|---|
| | adsorption | | Adsorption | |
| | capacity | Color | stability of | Color stability of lake |
| Samples | (mg/g) | (b value) | lake (%) | (Δb) |
| Example 1 | 0.36_{±0.03} | −20.2_{±0.36} | 28.0_{±2.59} | 0.19_{±0.22} |
| Comparative | 0.20_{±00.1} | −19.1_{±0.06} | 20.5_{±4.59} | 0.59_{±0.01} |
| example 1 | | | | |
| Comparative | 0.17_{±0.006} | −15.8_{±0.15} | 10.7_{±4.30} | 0.33_{±0.18} |
| example 2 | | | | |
| Comparative | 0.15_{±0.008} | −8.84_{±0.03} | 11.7_{±1.60} | 0.48_{±0.26} |
| example 3 | | | | |

It can be seen from the data in Table 1 that, compared with the lakes prepared in comparative examples 1-3, the lake prepared in example 1 achieves synchronous optimization in terms of pigment adsorption capacity, color, adsorption stability and color stability, thereby improving its practicability. Meanwhile, it is proved that the key technical steps claimed by this patent have substantial effects.

Compared with example 1, an operation of adjusting the pH is absent in comparative example 1, which causes a significant difference between adsorption abilities of lakes in example 1 and comparative example 1. The pigment adsorption capacity in example 1 is about 2 times that in comparative example 1. Similarly, comparative example 2 proves the importance of the reagent addition order. The method where pigment was added after calcium carbonate formation makes the adsorption capacity and adsorption stability of pigment less than half of those in example 1. However, application of the ultrasonic assisted technology has the most obvious effect, and both of the pigment adsorption capacity and color of the lake in example 3 with the lack of ultrasonic treatment are the lowest.

Table 1 only shows the research results using indigo carmine as investigated object. For other pigments, pigment adsorption capacity, color, adsorption stability, color stability and other performance testes are also conducted. The test results are similar to those of indigo carmine, so they are not shown here. The test results show that the technical solution claimed by this patent is of universal applicability.

The above descriptions are only preferred embodiments of the disclosure but are not intended to limit the disclosure. Any modifications, equivalent replacements, improvements and the like made within the spirit and principle of the disclosure shall be included within the protection scope of the disclosure.

We claim:

1. A method for preparing a calcium carbonate-based edible lake, comprising the following steps:
S1, dissolving carbonate in water to obtain carbonate solution;
S2, dissolving water-soluble anionic pigment into the carbonate solution obtained in step S1 to obtain mixed solution;
S3, adding hydrochloric acid to the mixed solution obtained in step S2 to adjust pH to 7-10.5;
S4, dissolving a calcium salt into water and then adding the above solution into the solution obtained in step S3, controlling the pH of the solution to 6-9, stirring and carrying out ultrasound treatment for 1-10 min, and centrifuging to obtain a calcium carbonate precipitate adsorbed with pigment; and
S5, drying and grinding the calcium carbonate precipitate adsorbed with pigment obtained in step S4 to obtain a calcium carbonate-based edible lake.

2. The method for preparing a calcium carbonate-based edible lake according to claim 1, wherein carbonate in step S 1 is sodium carbonate or potassium carbonate.

3. The method for preparing a calcium carbonate-based edible lake according to claim 1, wherein in step S2, the water-soluble anionic pigment is a mixture of one or more of erythrosine, indigo carmine, brilliant blue, tartrazine, amaranth, new red, Ponceau 4R, Allura Red AC and Sunset Yellow FCF.

4. The method for preparing a calcium carbonate-based edible lake according to claim 1, wherein in step S4, the calcium salt is a water-soluble calcium salt.

5. The method for preparing a calcium carbonate-based edible lake according to claim 4, wherein the water-soluble calcium salt is calcium chloride or calcium bicarbonate.

6. The method for preparing a calcium carbonate-based edible lake according to claim 1, wherein in step S4, the mole ratio of added calcium salt to carbonate is 1:1.

7. The method for preparing a calcium carbonate-based edible lake according to claim 1, wherein in step S4, the used ultrasonic frequency is 25-100 kHz.

8. The method for preparing a calcium carbonate-based edible lake according to claim 1, wherein in step S5, the drying operation is carried out at 40-80° C.
